(19) United States
(12) Patent Application Publication
(10) Pub. No.: US 2004/0016113 A1
(43) Pub. Date: Jan. 29, 2004

(54) Method and apparatus for supporting a substrate

(76) Inventors: Gerald Pham-Van-Diep, Hopkinton, MA (US); John E. Morini, Douglas, MA (US)

Correspondence Address: Thomas M. Sullivan, Esq., Mintz, Levin, Cohn, Ferris, Glovsky and Popeo, P.C, One Financial Center, Boston, MA, 02111, US

(21) Appl. No.: 10/175,131

(22) Filed: Jun. 19, 2002

(51) Int. Cl. B23P 19/00

(52) U.S. Cl. 29/729

(57) ABSTRACT

An apparatus and method for performing operations on an electronic substrate includes a frame, a transportation system that moves the substrate through the apparatus, a substrate support system coupled to the frame that supports the substrate during a manufacturing operation on the substrate, wherein the substrate support system includes a deformable material, and a device coupled to the frame that performs an operation on a surface of the substrate. Manufacturing operations are performed on the substrate while the substrate is substantially evenly supported by the deformable material.

### FIELD OF THE INVENTION

The invention relates to apparatus and methods for processing substrates such as circuit board assemblies, and more specifically to apparatus and methods for supporting a circuit board during the printing of solder paste on the circuit board, dispensing of material on the circuit board, placing of components on the circuit board, or some other operation.

### BACKGROUND OF THE INVENTION

The manufacturing of circuit boards involves many processes, one of which is surface mounting electrical components to the circuit boards. To surface mount components to a first surface of a circuit board, a dispenser deposits solder paste or adhesive onto the first surface of the circuit board, and then components are pressed against the solder paste or adhesive. After the first side of the circuit board has been populated with components, the board is inverted and the process is repeated to surface mount components to the second side of the board. The solder paste dispenser is typically a stenciling machine, and typically a turret-type device presses the components into the solder paste or adhesive.

When a circuit board is subjected to these manufacturing processes, it is often desirable to uniformly support the board across the lower surface so that the upper surface remains in substantially the same plane while a force is applied to the topside of the circuit board. Known means of supporting a circuit board during manufacturing operations are described in Beale, U.S. Pat. No. 5,157,438; Rossmeisl, U.S. Pat. No. 5,794,329; Barozzi, U.S. Pat. No. 4,936,560; Dougherty, U.S. Pat. No. 5,152,707; and Hertz, U.S. Pat. No. 6,264,187.

### SUMMARY OF THE INVENTION

In general, in one aspect, the invention provides an apparatus for performing operations on a surface of an electronic substrate. The apparatus includes a frame, a transportation system that moves the substrate through the apparatus, a substrate support system that supports the substrate during an operation on the substrate and that includes a deformable material, and a device coupled to the frame that performs an operation on the surface of the substrate.

Implementations of the invention may include one or more of the following features. The support system of the apparatus can be moveable from a lowered position to a raised position such that in the raised position, the deformable material contacts a side of the electronic substrate.

Further implementations of the invention may include one or more of the following features. The deformable material can be a low durometer gel. Alternatively, the deformable material can be a rheomagnetic fluid. The support member may include an electromagnetic cavity and the rheomagnetic fluid may be at least partially disposed in the electromagnetic cavity. Thin-walled tubes can be used to contain the rheomagnetic fluid. The support member can include a plurality of electromagnetic cavities, and a tube of rheomagnetic fluid can be disposed in each of the plurality of electromagnetic cavities. The electromagnetic cavities can be energized to solidify the rheomagnetic fluid.

In general, in another aspect, the invention provides a method of performing an operation on an electronic substrate. The method includes loading the substrate into a processing machine, supporting the substrate with a deformable material that conforms to a surface of the substrate, performing a manufacturing operation on the substrate, and removing the substrate from the processing machine. The electronic substrate can be a circuit board. The deformable material can be returned to a home position after the substrate is removed from the processing machine.

Generally, in another aspect, the invention provides an apparatus for supporting an electronic substrate during a manufacturing operation. The apparatus includes a frame and means coupled to the frame for supporting electronic substrates, including a deformable material which conforms to a surface of the substrate to be supported during manufacturing.

Implementations of the invention may include one or more of the following features. The supporting means may include a low durometer gel as the deformable material to support the substrate. Alternatively, the supporting means may include a rheomagnetic fluid as the deformable material. The supporting means can include further means for solidifying the rheomagnetic fluid.

The invention will be more fully understood after a review of the following figures, detailed description and claims.

### BRIEF DESCRIPTION OF THE FIGURES

For a better understanding of the present invention, reference is made to the drawings which are incorporated herein by reference and in which:

FIG. 1 is a top view of a printing apparatus in accordance with one embodiment of the invention;

FIG. 2A is a schematic diagram of support gel in a preparation stage in one embodiment of the invention;

FIG. 2B is a schematic diagram of support gel in a conformed stage in one embodiment of the invention;

FIG. 2C is a schematic diagram of support gel in a post-loaded stage in one embodiment of the invention;

FIG. 3A is a schematic diagram of rheomagnetic fluid in a pre-energized phase in one embodiment of the invention;

FIG. 3B is a schematic diagram of rheomagnetic fluid in a loaded phase in one embodiment of the invention; and

FIG. 3C is a schematic diagram of rheomagnetic fluid in an energized phase in one embodiment of the invention.

FIG. 4 is a schematic diagram of a top view of the rheomagnetic fluid support system in one embodiment of the invention.

### DETAILED DESCRIPTION OF PREFERRED EMBODIMENTS

Embodiments of the present invention are described below with reference to screen printers or stencil printers that print solder paste onto circuit boards. As understood by those skilled in the art, embodiments of the present invention can be used with electronic substrates other than circuit boards, such as electronic components, and with machines other than screen printers such as pick and place machines or dispensing machines.

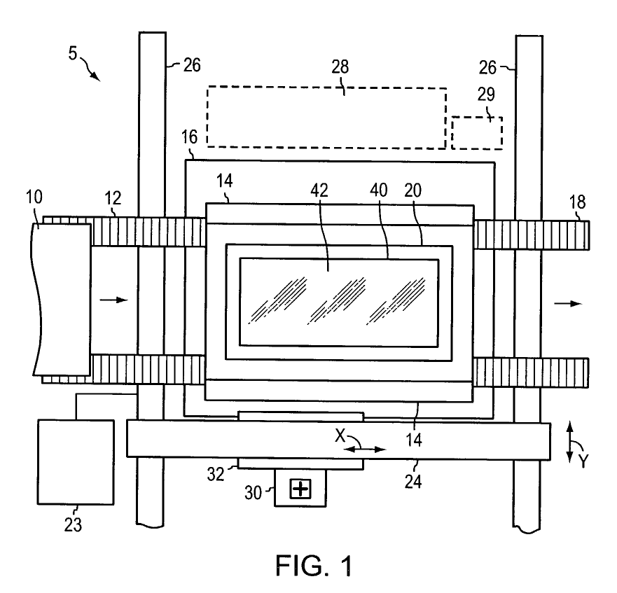

Referring to FIG. 1, internal components of a printer 5 in accordance with one embodiment of the invention that applies solder paste to circuit boards are shown. The printer is an improvement over screen printers described in U.S. Pat. No. 5,794,329, which is hereby incorporated by reference.

As shown in FIG. 1, the printer 5 includes a tractor feed mechanism 12, edge tractor mechanisms 14, a rigid support table 16, a board support mechanism 20, a moveable gantry 24, a controller 23, a squeegee/adhesive applicator 28, and a camera 30 carried on a carriage 32. The support mechanism 20 is located on and attached to the support table 16. The camera 30 carried on the carriage 32 is moveable along the gantry 24 in a linear X-axis of motion. The gantry 24 is moveable along tracks 26 in a linear Y-axis of motion. The squeegee/adhesive applicator 28 is attached to the printer 5 in a position above the level of the circuit board 10.

Boards 10 fed into the printer 5 usually have a pattern of pads or other, usually conductive surface areas onto which solder paste will be deposited. When directed by the controller of the printer, the tractor feed mechanism 12 supplies boards 10 to a location where the camera 30 records an image of the circuit board 10. The image is sent to the controller, which signals for the edge tractor mechanisms 14 to shuttle the board 10 to a second location over the rigid support table 16, beneath a solder stencil. Once arriving at a position over the support table 16, the circuit board 10 is in place for a manufacturing operation. To successfully perform operations on the board 10, the board 10 is supported by the support mechanism 20. The support mechanism 20 is raised from beneath the circuit board 10 at the direction of the controller. When the solder stencil and the circuit board 10 are aligned correctly, the stencil is lowered toward the board 10 for application of the solder paste or the board can be raised toward the stencil by the support mechanism. The squeegee/adhesive applicator 28, positioned above the circuit board 10, is shown in phantom in FIG. 1. The adhesive applicator 28 can vary the amount of solder paste or adhesive delivered on the stencil and applied by the squeegee. The squeegee 28 wipes across the stencil, thereby pushing solder paste through the stencil onto the board 10. After solder paste has been deposited on the circuit board 10, the support mechanism 20 moves downward away from the position of the board, under control of the controller. The controller then controls movement of the board 10 to the next location using the tractor mechanism 18, where electrical components 11 will be placed on the board.

As discussed, the circuit board 10 enters on the tractor feed mechanism 12 and stops when in a position over the table 16 where deposition of solder paste will occur. Throughout the process of printing the solder paste on the circuit board 10, a force is applied to a top surface of the board 10 by the squeegee. In order for the solder paste to be applied evenly, the circuit board 10 is supported using the support mechanism 20 to oppose the force being applied to the topside of the board 10. In embodiments of the invention, the support mechanism 20, which is attached to the printer above the surface of the table 16, includes a deformable material 42 in a support bed 40. The entire support mechanism 20 is attached to the printer frame in such a way that it can be raised to the surface of the circuit board 10, allowing the deformable material 42 to conform to the underside topography of the board 10 during printing. In this way, the deformable material 42 evenly supports the underside of the circuit board 10 due to its ability to conform to the topography of the circuit board 10.

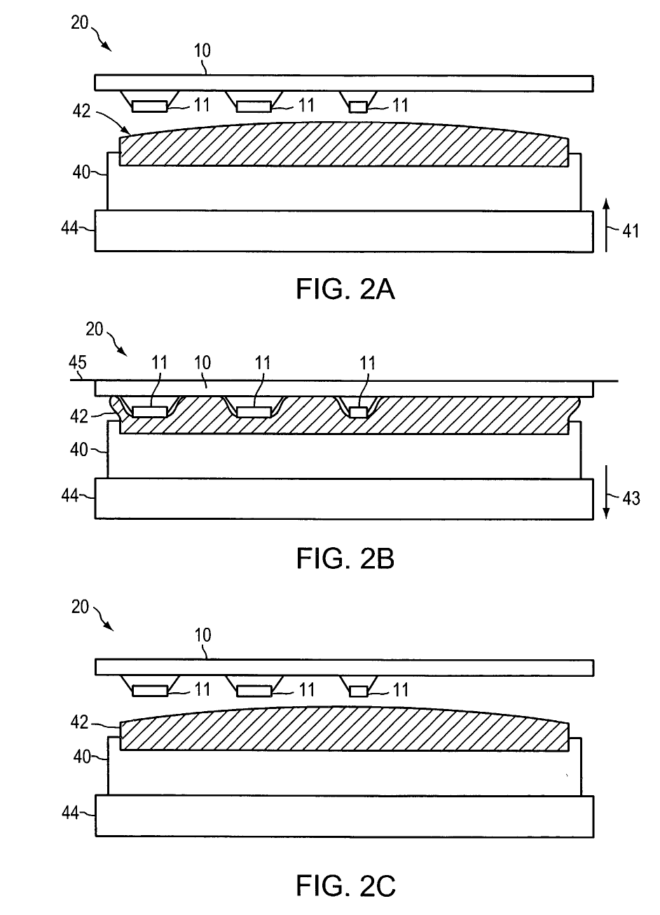

Referring to FIGS. 2A-2C, the support mechanism 20 is shown in greater detail. The support mechanism 20 includes a base 44, a housing 40 and a deformable material 42. The deformable material 42 is a low durometer gel contained in the housing 40, which functions as a support bed for containing the deformable material. In one embodiment, the low durometer gel 42 is a polyurethane gel, manufactured and distributed by Northstar Polymer, LLC, located in Minneapolis, Minn. under part no. MPP-V37A. In FIG. 2A, the support mechanism is shown moving in the direction of arrow 41 toward a circuit board 10 to support the board 10 in the printer 5. The underside of the circuit board is populated with electrical components 11.

FIG. 2B shows the support mechanism 20 in contact with the board 10 after a print operation has occurred. In FIG. 2B, a stencil 45 is still in contact with the board 10. Under compression caused by the contact of the gel 42 with the board 10, the gel 42 conforms to the underside topography of the circuit board 10, as shown in FIG. 2B, to provide evenly distributed support to the circuit board 10. The gel 42 is of a consistency such that it remains contained within the housing 40 even while under compression. Controlled by the controller, the gel 42 and support bed 40 are retracted from the surface of the board 10 in the direction of arrow 43 at the completion of processing the circuit board 10, and the entire support mechanism 20 returns to a home position, shown in FIG. 2C, where it will remain until the next board 10 is aligned for processing. As shown in FIG. 2C, the low durometer gel 42 returns to a relaxed state when the support mechanism 20 is in the home position. The low durometer gel 42 is then ready to conform to a board topography during a next print cycle.

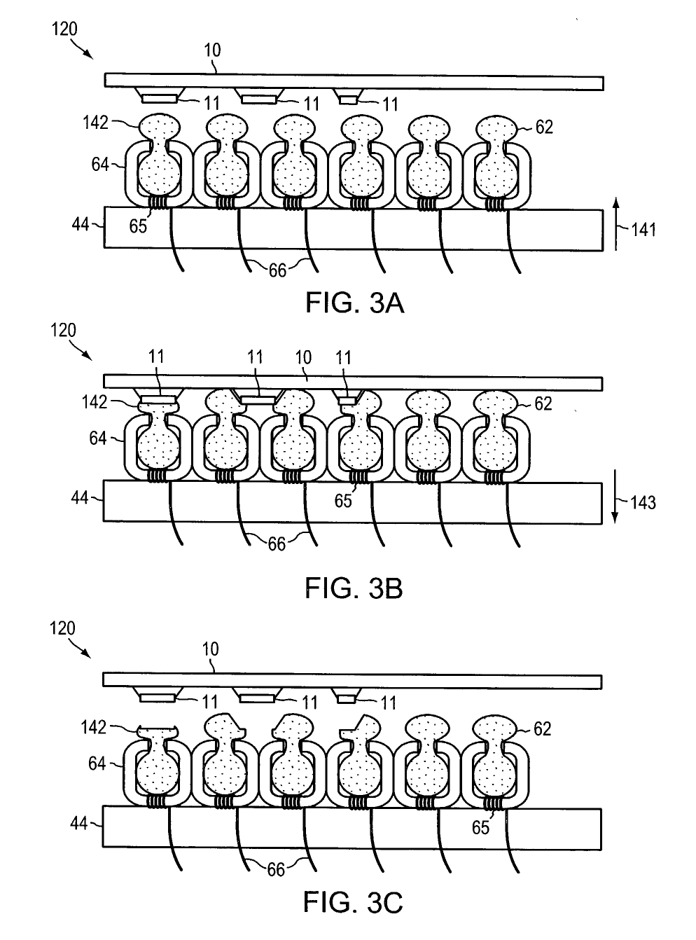

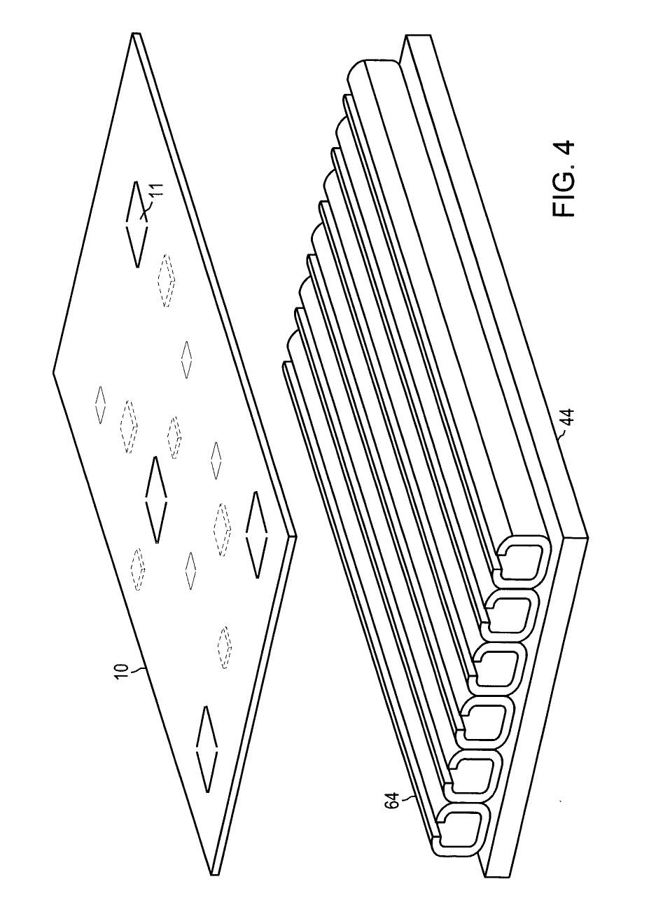

Alternatively, in another embodiment of the invention, which will now be described with reference to FIGS. 3A-3C and FIG. 4, a support mechanism 120 may be used to support a circuit board during printing in place of support mechanism 20, previously described. The support mechanism 120 includes a base 44, electromagnetic cavities 64, magnetic windings 65 and a deformable material 142. The deformable material 142 is a rheomagnetic fluid contained in thin-walled tubes 62, which may be made of latex, that are partially disposed in the electromagnetic cavities 64. In one embodiment, the rheomagnetic fluid is a mixture of small magnetic particles such as iron, and a viscous fluid such as oil or water, manufactured and available from Lord Corporation of Cary, N.C. under part nos. including MRF-132AD, MRF-132LD, MRF-241GS, MRF-240B5 and MRF-336AG. In one embodiment, the electromagnetic cavities are made of a magnetic material, such as iron. Common magnetic windings 65 line the base of the electromagnetic cavities 64. The electromagnetic cavities 64 are attached via connecting wires 66 to a source that provides electric current under control of the controller. As shown in FIG. 4, the electromagnetic cavities 64 can be aligned across the length of the base 44 of the support mechanism 120.

The support mechanism 120 operates as follows. A circuit board 10, having an underside populated with electrical components 11, is positioned over table 16 for the deposition of solder paste. The support mechanism 120 is moved under the control of the controller in the direction of arrow 141 until the rheomagnetic material contacts the underside of circuit board 10. While the support mechanism 120 approaches the underside of circuit board 10, the rheomagnetic fluid 142 is in a free, or relaxed state. In the relaxed state, the rheomagnetic fluid 142 easily conforms to the topography of the board 10 upon contact with the board 10. While the rheomagnetic fluid 142 is in contact with the board 10, the electromagnetic cavities 64 are energized with an electric current via connecting wires 66, which are also connected to a DC power source. The magnetic field is proportional to the direction and intensity of the electric current in the magnetic winding 65. Enough current must be provided to generate a magnetic field strong enough to align the particles in the rheomagnetic fluid 142. Energy from the electromagnetic cavities 64 transforms the tubes 62 of rheomagnetic fluid 142 from a fluid state to a rigid state. While in the rigid state, the rheomagnetic fluid 142 provides sufficient board support during manufacturing operations.

The configuration of the rheomagnetic fluid 142 when energized is such that it rigidly supports the surface of the board 10, whether the board 10 is populated with electrical components or not. The rheomagnetic fluid 142 will remain energized, or in a rigid state for as long as the electromagnetic cavities 64 remain energized with an electric current as shown in FIG. 3C. The rheomagnetic fluid remains energized in a shape conforming to a first circuit board 10 so that many circuit boards 10 having the same topography as the first circuit board 10 can be mass-produced without de-energizing and re-energizing the rheomagnetic fluid 142. Upon completion of processing of a board 10, the controller directs the support mechanism 120 to the lowered position in the direction of arrow 143.

If it is desired to process a second type of board, the electromagnetic cavities 64 are de-energized, thereby returning the rheomagnetic fluid 142 to a fluid state. The system resets for another print cycle when the support mechanism 120 is returned to a home position. The rheomagnetic fluid 142 is re-configured to support another set of circuit board assemblies with a different configuration of electrical components 11 by pressing the rheomagnetic fluid against the undersurface of a new circuit board 10 and energizing the electromagnetic cavities 64 with electric current once again.

In the embodiments of the present invention described above, the low durometer gel when used as the deformable material fills the housing container completely. As understood by those skilled in the art, other configurations may include strips of low durometer gel contained in the support housing, or other appropriate and strategic configurations of the gel that amply support the underside of the circuit board.

In embodiments of the present invention described above, the rheomagnetic fluid used as a deformable material is contained in an assembly of electromagnetic cavities, all of which comprise the support system. As understood by those skilled in the art, other configurations may include a single electromagnetic cavity containing rheomagnetic fluid such that the single container of rheomagnetic fluid is sufficiently energized to conform to the surface of the boards. The assembly of electromagnetic cavities may further be aligned across the width of the base of the support mechanism. In still further embodiments of the present invention, a connecting wire is attached to each of the electromagnetic cavities to provide electric current that energizes the electromagnetic cavities, which thereafter energizes the rheomagnetic fluid to make it rigid. As understood by those skilled in the art, other configurations may include a single set of connecting wires that provides electric current to all of the electromagnetic cavities in the assembly.

In still further embodiments of the present invention, the support mechanism is attached to the printer frame so that it moves in an upward direction toward the underside of the circuit board during manufacturing, when directed by the controller. As understood by those skilled in the art, other configurations may include a support mechanism in a fixed position whereby the boards are lowered to the deformable material of the support mechanism during manufacturing.

Having thus described at least one illustrative embodiment of the invention, various alterations, modifications and improvements will readily occur to those skilled in the art. Such alterations, modifications and improvements are intended to be within the scope and spirit of the invention. Accordingly, the foregoing description is by way of example only and is not intended as limiting. The invention's limit is defined only in the following claims and the equivalents thereto.

What is claimed is:

1. An apparatus for performing operations on at least one surface of an electronic substrate having a first surface and a second surface, the apparatus comprising:
a frame;
a transportation system that moves the substrate through the apparatus;
a substrate support system coupled to the frame that supports the substrate during an operation on the substrate, wherein the substrate support system includes a deformable material; and
a device coupled to the frame that performs an operation on a surface of the substrate.

2. The apparatus of claim 1 wherein the substrate support member is moveable from a lowered position to a raised position, wherein in the raised position the deformable material contacts a side of the electronic substrate.

3. The apparatus of claim 2 wherein the deformable material is a low durometer gel.

4. The apparatus of claim 2 wherein the deformable material is a rheomagnetic fluid.

5. The apparatus of claim 4 wherein the substrate support member includes at least one electromagnetic cavity and wherein the rheomagnetic fluid is at least partially disposed in the electromagnetic cavity.

6. The apparatus of claim 5 further comprising a thin-walled tube that houses the rheomagnetic fluid.

7. The apparatus of claim 6 wherein the at least one electromagnetic cavity is a plurality of electromagnetic cavities, and wherein a tube of rheomagnetic fluid is disposed in each of the plurality of electromagnetic cavities.

8. The apparatus of claim 1, wherein the device is a stencil and the substrate is a circuit board.

9. A method of performing an operation on an electronic substrate, the method comprising:
loading the substrate into a processing machine;
supporting the substrate with a deformable material that conforms to a surface of the electronic substrate;
performing a manufacturing operation on the substrate; and
removing the substrate from the processing machine.

10. The method of claim 9 wherein the electronic substrate is a circuit board.

11. The method of claim 7 further comprising returning the deformable material to a home position after the substrate is removed from the processing machine.

12. The method of claim 9 wherein the deformable material is a low durometer gel.

13. The method of claim 9 wherein the deformable material is a rheomagnetic fluid at least partially disposed in an electromagnetic cavity.

14. The method of claim 13 further comprising energizing the electromagnetic cavity to solidify the rheomagnetic fluid at least partially disposed in the electromagnetic cavity.

15. The method of claim 14 further comprising de-energizing the electromagnetic cavity.

16. An apparatus for supporting an electronic substrate during a manufacturing operation, the apparatus comprising:
a frame;
means, coupled to the frame, for supporting electronic substrates, including a deformable material which conforms to a surface of the substrate to be supported during manufacturing.

17. The apparatus of claim 16 wherein the deformable material is a low durometer gel.

18. The apparatus of claim 16 wherein the deformable material is a rheomagnetic fluid.

19. The apparatus of claim 18 further comprising means for solidifying the rheomagnetic fluid.

20. The apparatus of claim 16, further comprising a stencil and a device for depositing material on the stencil.
